(19) United States
(12) Patent Application Publication
(10) Pub. No.: US 2010/0023226 A1
(43) Pub. Date: Jan. 28, 2010

(54) Vehicle-mounted safety control apparatus

(75) Inventor: Yosuke Ito, Kariya-shi (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 12/457,466

(22) Filed: Jun. 11, 2009

(30) Foreign Application Priority Data
Jul. 28, 2008 (JP) 2008-193757

(51) Int. Cl. B60T 7/12

(52) U.S. Cl. 701/46

(57) ABSTRACT

The vehicle-mounted safety control apparatus includes a first function of detecting an object ahead of the vehicle, a second function of acquiring, as a time to collision, a ratio of a relative speed to a relative distance between the vehicle and the object, a third function of performing an automatic brake operation when the time to collision is smaller than or equal to a predetermined time, a fourth function of detecting acceleration of the vehicle, and a fifth function of acquiring, as a collision acceleration, acceleration detected within a period having a predetermined duration and straddling a time at which the time to collision becomes 0, and operating to continue the automatic brake operation if the collision acceleration is larger than or equal to a collision threshold preset to a value larger than acceleration produced by the automatic brake operation, and otherwise terminate the automatic brake operation.

### CROSS-REFERENCE TO RELATED APPLICATION

This application is related to Japanese Patent Application No. 2008-193757 filed on Jul. 28, 2008, the contents of which are hereby incorporated by reference.

### BACKGROUND OF THE INVENTION

1. Field of the Invention

The present invention relates to a vehicle-mounted safety control apparatus which performs safety control to prevent collision or reduce damage from collision with another vehicle, an obstacle, or a pedestrian.

2. Description of Related Art

There is known a vehicle-mounted safety control apparatus configured to calculate, as monitoring data, the distance and relative speed of another vehicle or an obstacle or a pedestrian (collectively referred to as a “forward obstacle” hereinafter) detected by use of a monitoring sensor such as a radar or a camera with respect to the vehicle on which the vehicle-mounted safety control apparatus is mounted (may be referred to as “own vehicle” hereinafter), and the position of the forward obstacle with respect to the traveling direction of the own vehicle, and to perform safety control to prevent collision or reduce damage from collision with the forward obstacle in accordance with the calculated monitoring data.

Such a vehicle-mounted safety control apparatus performs auxiliary brake control to assist braking operation performed by a vehicle driver by increasing a brake fluid pressure with respect to a depression amount of a brake pedal, when the vehicle-mounted safety control apparatus determines that there is a high possibility of collision. For more details, refer to Japanese Patent Application Laid-open No. 10-338110, for example. Also, such a vehicle-mounted safety control apparatus performs automatic brake control to forcibly activate automatic braking irrespective of the driver's operation when it is determined that collision is unavoidable. Fore more details, refer to Japanese Patent Application Laid-open No. 2008-132867, for example.

However, such a conventional vehicle-mounted safety control apparatus is configured that once the automatic braking is activated, the activation is continued until the speed of the vehicle becomes 0 unless a redetermination that collision is avoidable is made based on the monitoring data. This configuration causes the following problem when the forward obstacle cannot be detected by the monitoring sensor.

The situation where the forward obstacle cannot be detected by the monitoring sensor may occur when the forward obstacle has moved away from the vehicle, or when the vehicle is too close to the forward obstacle to detect the forward obstacle. In the former case, there may arise superfluous risk of collision with a following vehicle by the own vehicle making an unnecessary sudden stop.

### SUMMARY OF THE INVENTION

The present invention provides a vehicle-mounted safety control apparatus comprising:

a first function of detecting an object present ahead of a vehicle;

a second function of acquiring, as a time to collision, a ratio of a relative speed to a relative distance between the vehicle and the detected object;

a third function of performing an automatic brake operation on the vehicle when the acquired time to collision is smaller than or equal to a predetermined time;

a fourth function of detecting acceleration of the vehicle; and

a fifth function of acquiring, as a collision acceleration, acceleration detected by the fourth function within a period having a predetermined duration and straddling a time at which the time to collision becomes 0, and operating to continue the automatic brake operation if the acquired collision acceleration is larger than or equal to a collision threshold preset to a value larger than acceleration produced by the automatic brake operation, and terminate the automatic brake operation if the acquired collision acceleration is smaller than the collision threshold.

According to the above vehicle-mounted safety control apparatus, it is possible to terminate the automatic brake operation once activated if the likelihood of collision with an obstacle ahead of the vehicle is relatively low, to thereby prevent collision with an obstacle behind the vehicle such as the following vehicle.

The third function may perform the automatic brake operation to decrease deceleration of the vehicle to a target deceleration set by the fifth function, and the fifth function may terminate the automatic braking operation when setting the target deceleration to 0.

According to the above configuration, it is possible to smoothly change the vehicle from the automatic brake operation mode to the driver's operation mode when the vehicle speed becomes constant, if collision with an obstacle can be avoided.

The fifth function may set, as an acceleration slope, a proportional coefficient by which the target deceleration decreases linearly, such that the proportional coefficient is larger as the acquired collision acceleration is smaller.

According to the above configuration, it is possible to terminate the automatic brake operation once activated at an earlier timing as the likelihood of collision with an obstacle ahead of the vehicle becomes low, even if it is not possible to determine whether the vehicle has collided with the obstacle.

The vehicle-mounted safety control apparatus may further comprise a sixth function of acquiring, as a lateral offset, a distance between the detected object and an extension of a direction passing through a center portion of the vehicle along which the vehicle travels, the sixth function setting the acceleration slope larger as the acquired lateral offset becomes larger.

According to the above configuration, it is possible to determine that the likelihood of collision with an obstacle ahead of the vehicle is lower when the lateral offset is large, which enables making an accurate collision determination.

Other advantages and features of the invention will become apparent from the following description including the drawings and claims.

### BRIEF DESCRIPTION OF THE DRAWINGS

In the accompanying drawings:

FIG. 1 is a block diagram showing a structure of an in-vehicle LAN connected with a vehicle-mounted safety control apparatus according to an embodiment of the invention;

FIG. 2 is a flowchart showing safety control process performed by a control section of the vehicle-mounted safety control apparatus;

FIG. 3 is a flowchart showing brake control process performed by the control section of the vehicle-mounted safety control apparatus; and

FIG. 4 is a timing chart of an example of operation of the vehicle-mounted safety control apparatus.

### PREFERRED EMBODIMENTS OF THE INVENTION

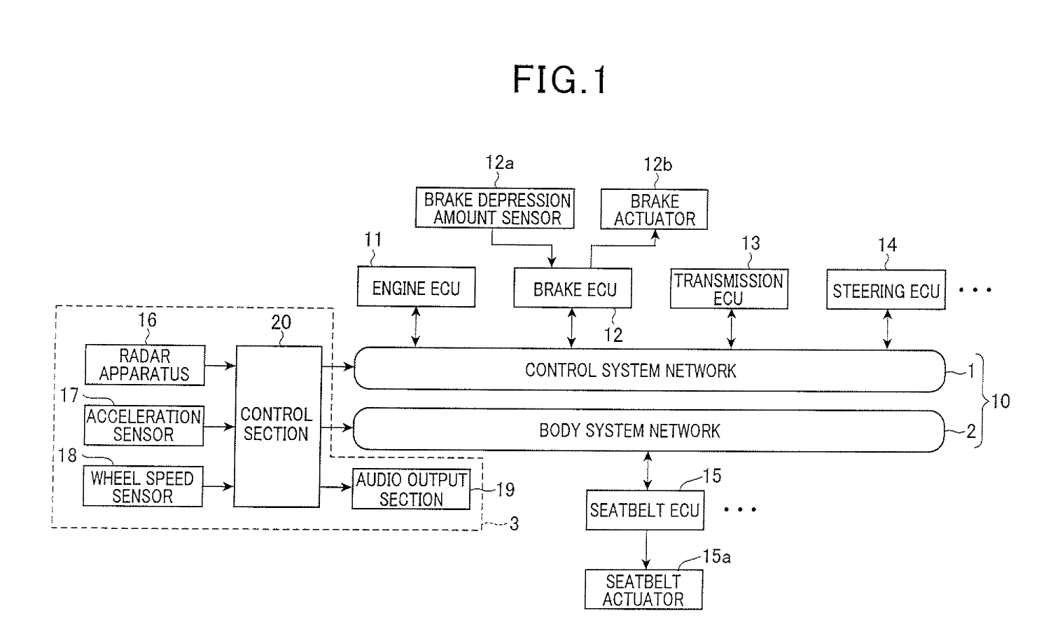

FIG. 1 is a block diagram showing a structure of an in-vehicle LAN connected with a vehicle-mounted safety control apparatus 3 according to an embodiment of the invention.

As shown in FIG. 1, the in-vehicle LAN is constituted of a control system network 1 connected with control system ECUs which operate to perform running control of the vehicle, and a body system network 2 connected with body system ECUs which operate to perform vehicle body control and provide various information. The vehicle-mounted safety control apparatus 3 is connected to both the network 1 and network 2.

The control system ECUs include an engine ECU 11 which controls start/stop of an engine (not shown) of the vehicle, fuel injection amounts and fuel injection timings, a brake ECU 12 which controls braking of the vehicle, a transmission ECU 13 which controls an automatic transmission of the vehicle, and a steering ECU 14 which performs steering control of the vehicle. Each of the ECUs 11 to 13 is configured to receive data or commands indicative of a target acceleration etc. from a following-distance-control ECU (not shown) which controls the distance with a preceding vehicle and the speed of the own vehicle through the control system network 1, to receive data or commands indicative of a target deceleration, the slope of the acceleration or deceleration of the own vehicle, etc. from the vehicle-mounted safety control apparatus 3 through the control system network 1, and to control the engine, or brake, or automatic transmission of the own vehicle so that the own vehicle is kept in a running state determined by the received data and command.

The brake ECU 12 includes a brake pedal depression amount sensor 12a which detects a depression amount of a brake pedal, and a brake actuator 12b which opens and closes a pressure increasing valve or a pressure reducing valve provided in a brake fluid pressure circuit in accordance with the output value of the brake pedal depression amount sensor 12a. The brake ECU 12 is configured to change the set value of the brake fluid pressure with respect to the depression amount of the brake pedal in accordance with a command received from the vehicle-mounted safety control apparatus 3 through the control system network 1.

The steering ECU 14 controls yaw moment (cornering ability) of the vehicle occurred when the steering wheel of the vehicle is operated. The steering ECU 14 is configured to change the set value of the yaw moment with respect to the operation amount of the steering wheel in accordance with a command received from the vehicle-mounted safety control apparatus 3 through the control system network 1.

The body system ECUs include a seatbelt ECU 15 which controls a seatbelt actuator 15a for driving a pretensioner for applying tension to each seatbelt. The seatbelt ECU 15 is configured to drive the pretensioner in accordance with a command received from the vehicle-mounted safety control apparatus 3 through the control system network 1.

Next, the structure of the vehicle-mounted safety control apparatus 3 is explained. The vehicle-mounted safety control apparatus 3 includes a radar apparatus 16 provided in a front part of the vehicle to detect an obstacle existing in a predetermined detection area ahead of the vehicle, an acceleration sensor 17 for detecting an acceleration of the vehicle, a wheel speed sensor 18 for detecting the speed of the vehicle from the rotational speed of the wheel, an audio output section 19 for outputting an alarm sound, and a control section 20 which performs various processes in accordance with the inputs from the radar apparatus 16 and sensors 17 and 18, and outputs various commands and data to the ECUs 11 to 15 through the in-vehicle LAN 10.

The radar apparatus 16, which is a so-called milliwave radar of the FMCW type, is configured to detect another vehicle, an obstacle, or a pedestrian ahead of the vehicle (collectively referred to as a forward obstacle hereinafter), produce target data on the basis of the detection result, and output the target data to the control section 20 at regular periods.

When the radar apparatus 16 detects a forward obstacle, the target data include at least the relative speed, relative distance and direction data of the detected forward obstacle. When the radar apparatus does not detect any forward obstacle, the target data include message indicating that no forward obstacle has been detected. The direction data show an angle between the extension of the direction passing through a center portion of the vehicle along which the vehicle travels (referred to as “vehicle center line” hereinafter) and the line extending from the lateral center of the vehicle on which the detected forward vehicle exists (referred to as “forward detection angle” hereinafter).

The control section 20 is mainly constituted by a microcomputer including a CPU, ROM, RAM, I/O and a bus. The CPU executes safety control process and brake control process described below in accordance with programs stored in the ROM by use of the RAM as a work area.

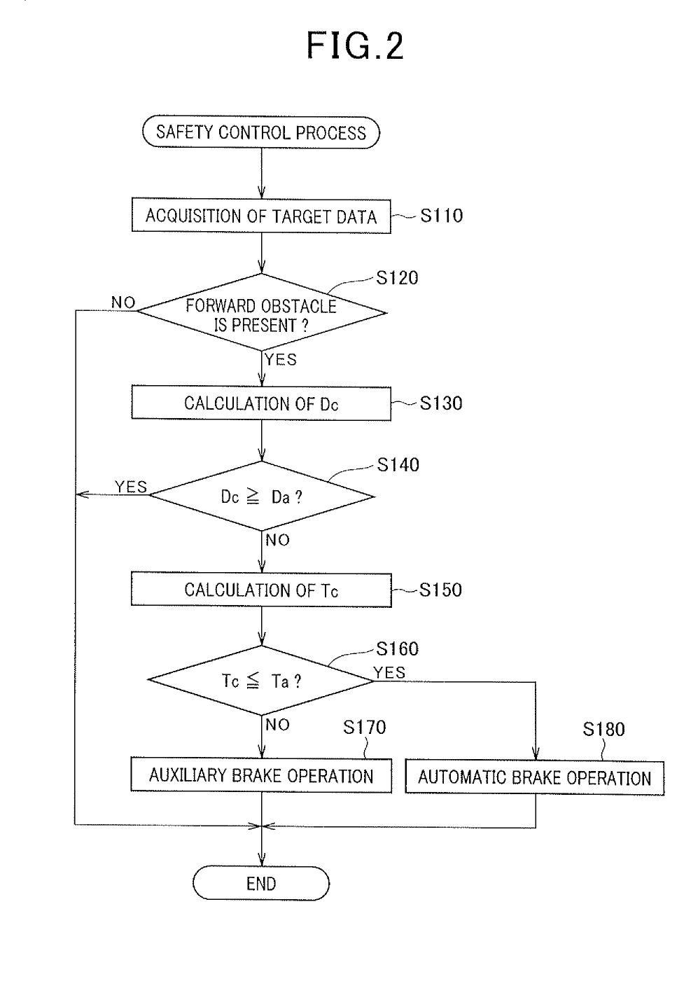

Next, the safety control process performed by the control section 20 is explained with reference to the flowchart shown in FIG. 2. This process is activated when the ignition switch of the vehicle is turned on, and performed repeatedly at regular periods (every 50 ms, for example) until the ignition switch is turned off.

As shown in FIG. 2, this process begins by acquiring the target data from the radar apparatus 16 at step S10, and then determines whether or not there is any forward obstacle ahead of the vehicle at step S120 on the basis of the acquired target data. If the determination result at step S120 is negative, the process is terminated.

If the determination result at step S120 is affirmative, the process proceeds to step S130 to calculate a distance between the vehicle centerline and the detected forward obstacle as a lateral offset Dc. The lateral offset Dc can be calculated from the relative distance of the forward obstacle with respect to the own vehicle, and the forward detection angle.

Subsequently, it is determined whether or not the lateral offset Dc calculated at step S130 is larger than or equal to a predetermined distance Da at step S140. If the determination result at step S140 is affirmative, the process is terminated. The distance Da is set to a distance larger than the width of the vehicle, or to such a distance that collision can be avoided without difficulty by some operation of the steering wheel. Accordingly, if the lateral offset Dc is larger than or equal to the distance Da, it can be assumed that possibility that the vehicle will collide with the forward obstacle is low.

On the other hand, if the determination result at step S140 is negative, the process proceeds to step S150 to calculate the time left before collision with the detected forward obstacle (referred to as “time to collision Tc” hereinafter). The time to collision Tc can be calculated from the ratio of the relative speed between the own vehicle and the forward obstacle to the relative distance between the own vehicle and the forward obstacle.

Subsequently, it is determined at step S160 whether or not the time to collision Tc calculated at step S150 is smaller than or equal to a predetermined time Ta. If the determination result at step S160 is negative, the process proceeds to step S170 to perform auxiliary brake operation, and thereafter the process is terminated. The time Ta is a time estimated to be left before collision occurs between the own vehicle and the forward obstacle when the own vehicle and the forward obstacle are so close each other that collision therebetween cannot be prevented if the movement states of the vehicle and the forward obstacle are not changed.

In the auxiliary brake operation at step S170, alarm sound is generated by the audio output section 19 if the time to collision Tc calculated at step S150 is smaller than or equal to a predetermined caution time Te (Te>>Ta). Further, if the time to collision Tc calculated at step S150 is smaller than or equal to a predetermined subsidiary time Tf (Te>>Tf>>Ta), commands are transmitted to the control system ECUs 12 and 14 to increase the set values of the brake fluid pressure and yaw moment.

On the other hand, if the determination result at step S160 is affirmative, the process proceeds to step S180 where automatic brake operation is performed to avoid collision with the forward obstacle, or to reduce collision damage when the collision is unavoidable. Thereafter, the process is terminated.

In the automatic brake operation at step S180, a command to forcibly activate an automatic braking system irrespective of the driver's operation, data showing the target deceleration (−8 m/s², for example), and data indicative of the deceleration slope (−20 m/s², for example) are transmitted to the brake ECU 12 through the control system network 1, and further a command to activate the pretensioner is transmitted to the seatbelt ECU 15. The deceleration slope is a proportional coefficient by which the deceleration is increased up to the target deceleration.

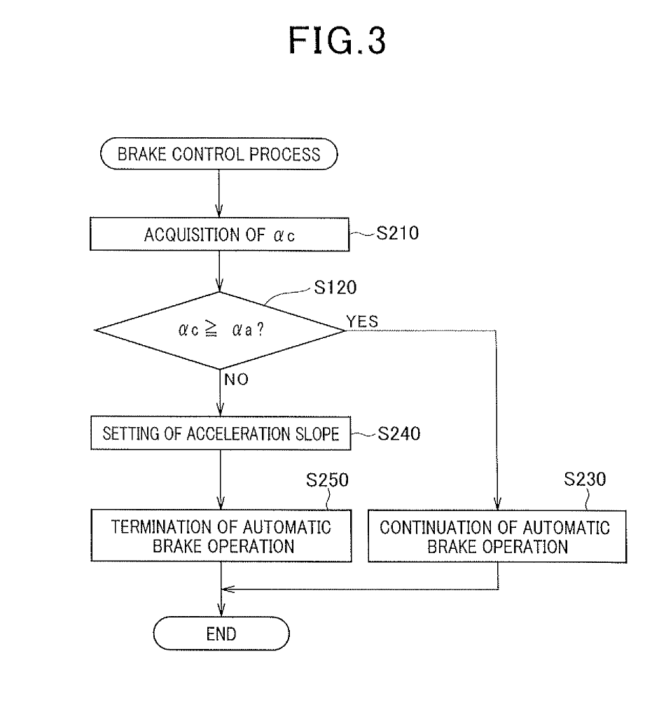

Next, the brake control process performed by the control section 20 is explained with reference to the flowchart shown in FIG. 3. This process is activated when the automatic brake operation at step S180 is started.

As shown in FIG. 3, this process begins by acquiring at step S210 a maximum one of a plurality of accelerations (referred to as “collision acceleration αc” hereinafter) detected by the acceleration sensor 17 within a period of a predetermined duration straddling the time at which the time to collision Tc calculated at step S150 becomes 0.

Next, it is determined whether or not the collision acceleration αc acquired at step S210 is larger than or equal to a predetermined collision threshold αa at step S220. If the determination result at step S220 is affirmative, the process proceeds to step S230 where braking continuation process in which a command to continue the automatic brake operation is transmitted to the ECUs 11 to 15 is performed, and then the process is terminated.

The collision threshold αa is set to a value at least larger than the acceleration caused to the vehicle by the automatic brake operation, for example, 110 to 300 m/s². The braking continuation process at step S230 is continued until the speed of the vehicle detected by the wheel speed sensor 18 becomes 0 with the target deceleration being kept constant, and thereafter terminated when the engine ECU 11 detects that the accelerator pedal of the vehicle has been depressed, for example.

On the other hand, if the determination result at step S220 is negative, the process proceeds to step S240 to set the acceleration slope on the basis of the collision acceleration αc and the lateral offset Dc calculated at step S130. The acceleration slope is a proportional coefficient by which the deceleration of the vehicle is decreased linearly until the target deceleration decreases to 0. For example, the acceleration slope is set to such a value that is inversely proportional to the collision acceleration αc, and directly proportional to the lateral offset Dc.

At subsequent step S250, braking termination process is performed to terminate the automatic brake operation through the control system ECUs 11 to 15 in accordance with the acceleration slope set at step S240, and then, the process is terminated.

In the braking termination process at step S250, a command to terminate the automatic brake operation when the deceleration of the vehicle becomes equal to the target deceleration (0, for example) and data indicative of the acceleration slope set at step S230 are transmitted to the brake ECU 12 and so forth, and a command to activate the pretensioner is transmitted to the seatbelt ECU 15.

Next, an example of operation of the vehicle-mounted safety control apparatus 3 is explained. When the radar apparatus 16 detects a preceding vehicle, the vehicle-mounted safety control apparatus 3 having the above described structure estimates likelihood of collision with the preceding vehicle (refereed to as a “first collision likelihood” hereinafter) at a plurality of levels (at three levels in this embodiment) by calculating the time to collision Tc on the basis of the target data of the preceding vehicle, and performs safety control.

When the time to collision Tc becomes smaller than the caution time Te (three seconds, for example), the vehicle-mounted safety control apparatus 3 assumes that the first collision likelihood exists though it is at a low level, and generates the warning sound to call the driver's attention. When the time to collision Tc becomes a value between the caution time Te and the subsidiary time Tf (1.8 seconds, for example), the vehicle-mounted safety control apparatus 3 assumes that the first collision likelihood is at the middle level, and assists the driver's braking operation by increasing the brake fluid pressure with respect to the depression amount of the brake pedal. When the time to collision Tc becomes smaller than the time Ta (0.6 seconds for example), the vehicle-mounted safety control apparatus 3 assumes that the first likelihood is at the high level, and activates the automatic braking system irrespective of the driver's operation.

Once the automatic braking system is activated, the vehicle-mounted safety control apparatus 3 estimates likelihood of collision with the preceding vehicle (referred to as a “second collision likelihood” hereinafter) at a plurality of levels on the basis of the collision acceleration αc detected within a period of a predetermined duration (1 second, for example) straddling the time at which the time to collision Tc becomes 0 and the calculated lateral offset Dc, and changes the manner of terminating the automatic brake operation depending on the estimated second collision likelihood.

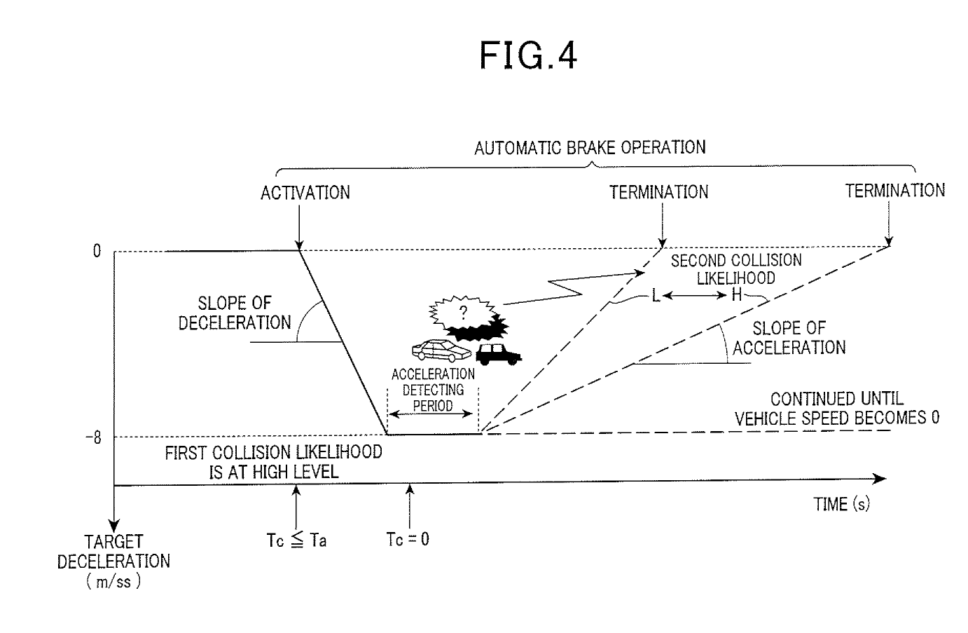

More specifically, as shown in FIG. 4, when the collision acceleration αc is larger than or equal to the collision threshold αa, the vehicle-mounted safety control apparatus 3 assumes that the second collision likelihood is at the high level, and continues the automatic brake operation until at least the speed of the vehicle becomes 0 to reduce damage due to collision to as little as possible.

On the other hand, when the collision acceleration αc is smaller than the collision threshold αa, there is a possibility of avoiding collision (or the second collision likelihood is sufficiently low) if the collision acceleration αc is small or the lateral offset Dc is large. Accordingly, in order to reduce the possibility of collision with the following vehicle, the vehicle-mounted safety control apparatus 3 sets the acceleration slope larger when the second collision likelihood is lower, and terminates the automatic brake operation when the deceleration of the vehicle becomes 0 (or immediately before the vehicle is stopped).

The above described embodiment of the invention provides the following advantages. As explained above, the vehicle-mounted safety control apparatus 3 starts the brake control process when the automatic braking system is activated to perform the automatic brake operation by the safety control process, and variably sets the acceleration slope as reference data to terminate the automatic brake operation depending on the collision acceleration αc detected by the acceleration sensor 17 within the acceleration detecting period (the period of a predetermined duration straddling the time at which the time to collision Tc becomes 0).

Accordingly, according to the vehicle-mounted safety control apparatus 3 of this embodiment, it is possible to safely terminate the automatic brake operation depending on the collision acceleration αc such that the timing of the termination becomes earlier as the collision acceleration αc becomes smaller, even when it cannot be determined whether the own vehicle has collided with the detected forward obstacle.

Furthermore, according to the vehicle-mounted safety control apparatus 3 of this embodiment, since the manner of terminating the automatic brake operation is changed depending on the collision acceleration αc detected by the acceleration sensor 17 within the acceleration detecting period even if the collision acceleration αc cannot be detected at the time when the time to collision Tc becomes 0, variation of the time to collision Tc due to variation of the relative speed between the own vehicle and the detected forward obstacle can be absorbed.

The vehicle-mounted safety control apparatus 3 is configured to achieve its safety control function by transmitting control commands and data to the control system and body system ECUs 11 to 15 connected to the vehicle-mounted safety control apparatus 3 thorough the in-vehicle LAN 10. Hence, since the vehicle-mounted safety control apparatus 3 is not required to directly control various actuators such as the brake actuator 12, etc., its control load thereof can be reduced.

### Other Embodiments

It is a matter of course that various modifications can be made to the above embodiment of the present invention as described below.

Although the radar apparatus 16 is used to detect a forward obstacle in the above embodiment, a vehicle-mounted camera may be used instead of the radar apparatus 16. In this case, sensors for detecting the yaw rate and steering angle of the vehicle may be additionally provided in order to estimate the travel track of the own vehicle on the travel road pictured by the vehicle-mounted camera, and to use the estimated travel track to calculate the lateral offset Dc instead of using the vehicle center line.

The vehicle-mounted safety control apparatus 3 of the above embodiment is configured to perform the automatic brake operation through the brake ECU 12 etc., when the time to collision Tc is smaller than the time Ta. However, the vehicle-mounted safety control apparatus 3 may be modified to perform automatic steering control to prevent collision with a detected forward obstacle in conjunction with the automatic brake operation.

In the above embodiment, the brake control process uses a maximum one of a plurality of the collision accelerations detected by the acceleration sensor 17 within the period of a predetermined duration straddling the time at which the time to collision Tc calculated at step S150 becomes 0 to determine whether the automatic brake operation should be terminated. However, the brake control process may use a time-integrated value of the collision acceleration detected during the acceleration detecting period to make the determination.

Further, in the above embodiment, the brake control process terminates the automatic brake operation only after waiting until the speed of the own vehicle detected by the wheel speed sensor 18 becomes 0 while keeping the target deceleration constant if the collision acceleration αc is larger than or equal to the collision threshold αa. However, the brake control process may be modified to increase the target deceleration to further increase the braking force, or to terminate the automatic brake operation before the speed of the own vehicle becomes 0 if the vehicle is assumed to be substantially stopped.

Further, although the brake control process terminates the automatic brake operation when the deceleration of the vehicle becomes 0 if the collision acceleration αc is smaller than the collision threshold αa in the above embodiment, it may be modified to terminate the automatic brake operation after elapse of a predetermined operation continuing time which is set to such a value that the vehicle can be prevented from making a sudden stop.

The vehicle-mounted safety control apparatus 3 of the above embodiment is configured to transmit control commands to the ECUs connected to the vehicle-mounted safety control apparatus 3 through the in-vehicle LAN 10. However, the vehicle-mounted safety control apparatus 3 may be integrated in one of the ECUs, for example, in the brake ECU 12.

The above explained preferred embodiments are exemplary of the invention of the present application which is described solely by the claims appended below. It should be understood that modifications of the preferred embodiments may be made as would occur to one of skill in the art

What is claimed is:

1. A vehicle-mounted safety control apparatus comprising:
a first function of detecting an object present ahead of a vehicle;
a second function of acquiring, as a time to collision, a ratio of a relative speed to a relative distance between said vehicle and said detected object;
a third function of performing an automatic brake operation on said vehicle when said acquired time to collision is smaller than or equal to a predetermined time;
a fourth function of detecting acceleration of said vehicle; and
a fifth function of acquiring, as a collision acceleration, acceleration detected by said fourth function within a period having a predetermined duration and straddling a time at which said time to collision becomes 0, and operating to continue said automatic brake operation if said acquired collision acceleration is larger than or equal to a collision threshold preset to a value larger than acceleration produced by said automatic brake operation, and terminate said automatic brake operation if said acquired collision acceleration is smaller than said collision threshold.

2. The vehicle-mounted safety control apparatus according to claim 1, wherein said third function performs said automatic brake operation to decrease deceleration of said vehicle to a target deceleration set by said fifth function, and said fifth function terminates said automatic braking operation when setting said target deceleration to 0.

3. The vehicle-mounted safety control apparatus according to claim 2, wherein said fifth function sets, as an acceleration slope, a proportional coefficient by which said target deceleration decreases linearly, such that said proportional coefficient is larger as said acquired collision acceleration is smaller.

4. The vehicle-mounted safety control apparatus according to claim 3, further comprising a sixth function of acquiring, as a lateral offset, a distance between said detected object and an extension of a direction passing through a center portion of said vehicle along which said vehicle travels, said sixth function setting said acceleration slope larger as said acquired lateral offset becomes larger.
